(19) United States
(12) Patent Application Publication
(10) Pub. No.: US 2011/0308747 A1
(43) Pub. Date: Dec. 22, 2011

(54) Anti-dust door

(76) Inventor: Peter Starzomski, Park Ridge, IL (US)

(21) Appl. No.: 12/801,607

(22) Filed: Jun. 16, 2010

(51) Int. Cl. E06B 9/38; E06B 9/00

(52) U.S. Cl. 160/368.1; 160/127

(57) ABSTRACT

The present disclosure teaches an easy to use anti-dust door which allows for the easy opening and closing of a temporary plastic or cloth sheeted door is positioned in a doorway between the room in which construction work is to take place and the rest of the building. The plastic sheet may be transparent, translucent or may even have a colored tint. The plastic sheet may be made out of virtually any flexible plastic sheeting. The plastic sheet further includes a single zipper for the opening and closing of the anti-dust door. This zipper wraps around three of the sides of the plastic door. The present disclosure teaches an easy to use anti-dust door which allows for the easy opening and closing of the door by anyone. The plastic sheet further includes a single zipper for the opening and closing of the anti-dust door. This zipper wraps around three of the sides of the plastic door.

### BACKGROUND OF THE DISCLOSURE

During the construction in a room of a building, workers have jerry rigged a number of methods to keep dust and/or asbestos from spreading to the rest of the structure.

U.S. Pat. No. 4,794,974 (Melino) discloses an interior curtain wall to prevent dust being transported from one area to another has an elongated flexible curtain that is supported on a plurality of interconnected headers, each header connected to the next by a flexible hinge and being supported against the ceiling by a support leg that is adjustable in length and has a spring loaded foot to maintain pressure against the header.

U.S. Pat. No. 5,345,989 (Brophy) discloses a curtain support device makes use of temporarily mounted carrier means for supporting the curtain over such an unobstructed opening which curtain is to be attached upon means supported on the edges of wall that define the opening in the wall for surrounding substantially the entire opening for a door or an archway or the like, the carrier having means fixed thereto that cooperate with means fixed to the periphery of a curtain that is to be mounted over the opening. The curtain carrying structure preferably is made up of a plurality of U shaped elements that can be quickly fitted to the wall surfaces by spreading the legs of the U to be fitted around and be supported on the wall edges that define the opening to be covered. The legs of the mounted carrying elements have a sufficiently tight engagement with the surface of the wall to hold the curtain taut when the curtain is mounted on the carrier to hold it in place.

U.S. Patent Application No. 2006/0283562 (Hickey) discloses a detachable dust-impermeable material based screen with a resealable rolled door access panel with zip openings and hooks & loop panels which can be secured to standard internal and external household doors or similar building apertures to prevent dust transfers from room to room. Preferably the invention is made from fabrics or plastic and is secured to a door surround with adhesive tape or alike which seals and also prevents dust contamination.

### SUMMARY OF THE DISCLOSURE

The present disclosure teaches an easy to use anti-dust door which allows for the easy opening and closing of the door by anyone.

In one embodiment of the disclosure, a plastic sheet is positioned in a doorway between the room in which construction work is to take place and the rest of the building.

In another embodiment of the disclosure, the plastic sheet is transparent.

In another embodiment of the disclosure, the plastic sheet is translucent.

In one embodiment of the disclosure, the plastic sheet is colored.

In another embodiment of the disclosure, the sheet is made out of a fabric.

The plastic sheet may be made out of virtually any flexible plastic sheeting.

The plastic sheet further includes a single zipper for the opening and closing of the anti-dust door. This zipper wraps around three of the sides of the plastic door.

In another embodiment of the disclosure, a hook and loop strap is positioned on one side of the plastic sheet, and is complementary to another hook and loop strap positioned on another side of the plastic sheet, to secure the door panel when in the open position.

In another embodiment of the disclosure, the anti-dust door is particularly sized for certain portals, and include a lip for securing the anti-dust door to the portal.

The anti-dust door is inexpensive, and easy to use. It can be used by anybody, and can be used for virtually any sized door. It is impermeable to dust, asbestos, and the elements. The anti-dust door may be used inside or outside. By using the anti-dust door, the amount of dust traversing through the portal is greatly reduced.

The arrangement of the zipper and the hook and loop straps allows for ease of use of the anti-dust door. In combination with the special tape that is included in anti-dust door kits, the anti-dust door can easily and quickly be erected in virtually any door opening (portal). The anti-dust door can be used over and over again, and the amount of preparation time for a construction job is reduced, thereby allowing for a more productive use of time.

In another embodiment of the disclosure, the anti-dust door is particularly sized for certain portals, and include a lip for securing the anti-dust door to the portal.

For a fuller understanding of the nature and advantages of the present invention, reference should be made to the following detailed description taken together with the accompanying figures.

### BRIEF DESCRIPTION OF THE FIGURES

FIG. 1 is a frontal view of the anti-dust door positioned in the doorway;

FIG. 2 is a frontal view of the reverse face of an open anti-dust door; and

FIG. 3 is another embodiment of the anti-dust door.

### DETAILED DESCRIPTION OF THE DISCLOSURE

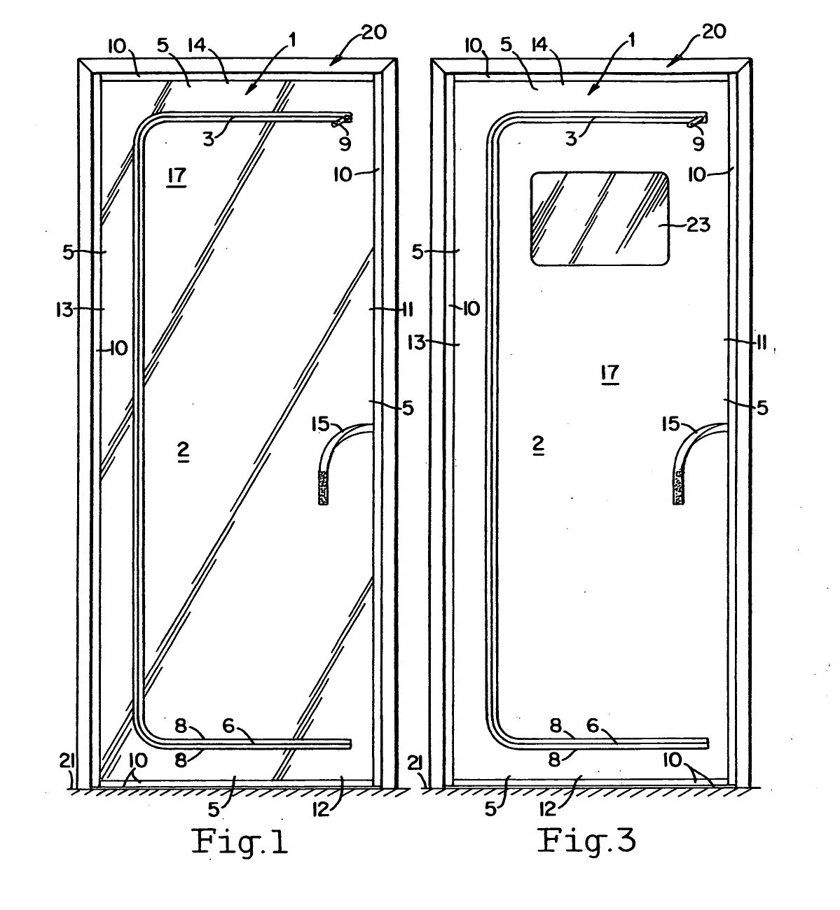

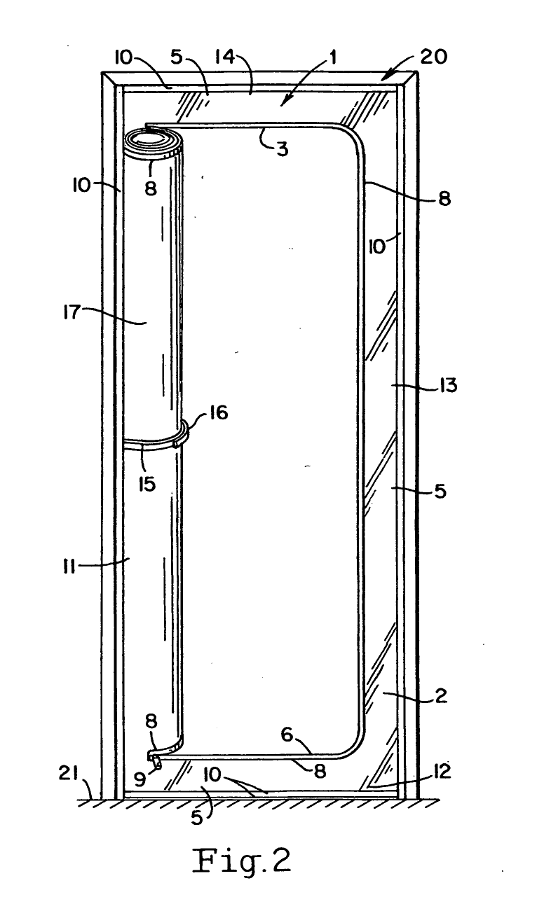

Referring to FIGS. 1-4, the anti-dust door 1 comprising a plastic sheet 2. The plastic sheet 2 may be transparent or translucent, and may be clear or colored. The plastic sheet is may made of polyethyelene plastic, and can be made out of recycled materials; however, other plastic sheets may be used, as long as they are impermeable to dust or asbestos, or other small particles, and as long as the sheet is flexible, and not brittle. In another embodiment, the sheet may be a dust impermeable cloth, instead of a sheet of plastic. The cloth may include a transparent plastic window 3, for so one may view the construction work on the other side of the anti-dust door. These transparent plastic windows may be secured to the cloth by means of an adhesive.

The plastic sheeting is large enough to fit just about any size standard door (normally 28-36 inches wide standard doors), but the anti-dust door 1 could be modified for any large openings. In one embodiment, the anti-dust door 1 could be made for larger doors, i.e., wider doors, taller door, etc. In another embodiment plastic strips could be included in the anti-dust door kit, such that the plastic strips could be taped to the existing plastic sheet 2.

The plastic sheet 2 further includes a zipper 3 which continuously runs around three sides of the plastic sheet. The zipper is used to open and close the door, so that the plastic sheet does not have to be removed from the doorway during the length of the construction project. It is much easier to pass through the zippered doorways than to remove the plastic or any tape supporting the plastic everytime someone walks in and out of the construction site. The zipper 3 may be positioned from one to twelve inches from the edge 5 of the plastic sheet 2. In one embodiment of the disclosure, the zipper chain 6 is positioned within about six to eight inches of the edges 5 of the sheet. Near the bottom of the sheet, the zipper chain 6 may be positioned less than six inches from the edges of the plastic sheet 2. In fact, the zipper chain 6 may be positioned less than eight inches from the edges 5 of the plastic sheet 2. There is a reasonable amount of variability of the positioning of the zipper chain 6 in relation to the plastic sheet 2. While the width of the plastic may vary, one to two mm thick (or more) will give the sheet a certain amount of strength.

The zipper chain is sewn or glued into the sheet 2. On each side of the zipper chain 6 is a plastic or cloth strip 8 either integral with or glued onto the plastic sheet 2. The plastic strips 8 overlap the zipper chain 6, such that dust does not enter the “clean room” through the zipper track 6. It should be noted that the pull tap 9 of the zipper is located on opposite sides of the zipper 3, such that the pull tab is on an opposite face of the plastic sheet 2.

In an alternative embodiment, a hook and loop mechanism may be used in place of the zipper. The hook and loop strips sewed, glued or integral with the plastic must also be covered by plastic strips to prevent dust from exiting the room.

The plastic sheet 2 is usually held up by an adhesive of some sort. One form of adhesive that can be used is an adhesive tape 10. Furthermore, the adhesive tape may be of the sort that is removable, without adhesive transfer to the door portal 20 to which the anti-dust door 1 is removably attached. Painter's tape may be used to hold up the plastic sheet 2. These tapes do not, or should not, remove any paint from around the doorway.

Whatever adhesive tape 10 is used, the adhesive tape 10 attaches the anti-dust door to the outside trip or wall surrounding the portal 20 of the room where construction is taking place. It should be noted that it is advisable that the anti-dust door 1 be taped in such a way that the anti-dust door is taut, and provides a tight seal. More specifically, each of the four sides 11, 12, 13, 14, of the anti-dust door 1 are secured to the trimp of the portal 15, by the adhesive tape 10, with the bottom side 12 attached to the floor 21 of the portal. To exit the room where construction (or demolition) is taking place, one merely opens the zipper positioned around at least three sides 12, 13, 14 of the anti-dust door, the zipper positioned around the bottom side, one longitudinal side, and a top side of the sheet 2.

In another embodiment of the disclosure, there are a pair of hook and loop strips (aka Velcro strips), with each of the two strips 15, 16 positioned on either face of the anti-dust door 1, in opposing positions. These strips are used to secure the door flap 17 of the anti-dust door 1 when the door is unzipped, and open. More specifically, a first hook and loop strip is positioned on one face of the plastic sheet, and a second hook and loop strip is positioned on a second face of the plastic sheet. The first hook and loop strip and the second hook and loop strip are positioned opposite each other with a distal end of said first hook and loop strip and the distal end of the second hook and loop strip being positioned at or near an edge of the second longitudinal side of said plastic sheet. The first hook and loop strip and the second hook and loop strip extend perpendicular to the second longitudinal side and laterally along the first face and second face of the plastic sheet.

It should be noted that the anti-dust door and the adhesive tape may be sold as a kit.—

Further, this anti-dust door can be made with a heavy duty plastic (two to three or more millimeters thick) construction trade. A waterproof tape can be used for outdoor usage.

It should be further understood by those skilled in the art that although the foregoing description has been made on embodiments of the disclosure, the disclosure is not limited thereto and various changes and modifications may be made without departing from the spirit of the invention and the scope of the appended claims.

What we claim is:

1. An anti-dust door, comprising:
a) a sheet large enough cover a door portal, said sheet having a bottom side, a top side, a first longitudinal side, and a second longitudinal side; and
b) a zipper, said zipper positioned around the perimeter of three of four sides of said sheet, said zipper positioned around said bottom side, said top side, and said first longitudinal side.

2. The anti-dust door of claim 1, wherein material for said sheet is selected from the group consisting of a cloth sheet and a plastic sheet.

3. The anti-dust door of claim 2, wherein said sheet is said plastic sheet.

4. The anti-dust door of claim 3, wherein said plastic sheet is transparent.

5. The anti-dust door of claim 3, wherein said plastic sheet is translucent.

6. The anti-dust door of claim 3, wherein aid plastic sheet is color tinted.

7. The anti-dust door of claim 1, further comprising a first hook and loop strip positioned on one face of the plastic sheet, and a second hook and loop strip position on a second face of the plastic sheet, said first hook and loop strip and said second hook and loop strip being positioned opposite each other with a distal end of said first hook and loop strip and said distal end of said second hook and loop strip being positioned at or near an edge of the second longitudinal side of said plastic sheet, wherein the first hook and loop strip and the second hook and loop strip extend perpendicular to the second longitudinal side and laterally along the first face and second face of the plastic sheet.

8. A kit for sealing a door portal, said kit comprising:
a) An anti-dust door, comprising:
i) a sheet large enough cover a door portal, said sheet having a bottom side, a top side, a first longitudinal side, and a second longitudinal side; and
ii) a zipper, said zipper positioned around the perimeter of three of four sides of said sheet, said zipper positioned around said bottom side, said top side, and said first longitudinal side; and
b) adhesive tape.
